(19) United States
(12) Patent Application Publication
(10) Pub. No.: US 2019/0016269 A1
(43) Pub. Date: Jan. 17, 2019

(54) MOUNTABLE CLIP HOLSTER

(71) Applicant: Christopher Beach, Erwinville, LA (US)

(72) Inventor: Christopher Beach, Erwinville, LA (US)

(21) Appl. No.: 16/032,910

(22) Filed: Jul. 11, 2018

Related U.S. Application Data
(60) Provisional application No. 62/530,926, filed on Jul. 11, 2017.

(51) Int. Cl. B60R 7/14

(52) U.S. Cl. CPC B60R 7/14

(57) ABSTRACT

A mountable clip to support a gun holster that includes: a base; a lateral support extending from each side of the base; a mounting clip extending from each lateral support; and a plurality of holes in each mounting clip and base adapted to provide a means to mount the clip onto a surface. Each lateral support extends at a 90-degree angle from the base. Each mounting clip extends at a 90-degree angle from each respective lateral support. A screw may be provided for each hole of the mountable clip.

### CROSS REFERENCE TO OTHER APPLICATIONS

This application claims priority to U.S. Provisional Application Ser. No. 62/530,926 filed on Dec. 31, 2008.

### BACKGROUND OF THE INVENTION

### Field of Invention

The present invention relates to mountable clip holster that provides a convenient means to mount a holster a handgun.

### Description of Related Art

Many individuals carry guns through for protective purposes and are required to obtain a permit to carry a concealed weapon. The number of concealed weapon permits have increased over the years due to general societal conditions and public opinions. Concealed weapons are normally holstered in a gun holster and may be used for protection and/or hunting purposes by individuals. However it sometimes could be inconvenient or impractical to carry a holster gun in a vehicle due to the type of holster that may be worn by the user. Further the user of such a handgun would normally want ready access to the gun for protective purposes. As a result, it would be advantageous to have a clip that could be easily installed to holster a pistol in a vehicle or even in a home so that an individual could have ready access to a gun as needed.

### SUMMARY OF THE INVENTION

The present invention relates to a mountable clip to support a gun holster that includes: a base; a lateral support extending from each side of the base; a mounting clip extending from each lateral support; and a plurality of holes in each mounting clip and base adapted to provide a means to mount the clip onto a surface. Each lateral support extends at a 90-degree angle from the base. Each mounting clip extends at a 90-degree angle from each respective lateral support. A screw may be provided for each hole of the mountable clip.

### BRIEF DESCRIPTION OF DRAWINGS

FIG. 1A shows a first side view of the mounted holster clip in accordance with the present invention.

FIG. 1B shows a second side view of the holster clip in accordance with the present invention.

FIG. 2 depicts a profile view of the holster clip in accordance with the present invention

### DETAILED DESCRIPTION

The present invention relates to a mounted holster clip that is mounted to allow a user to holster a handgun within the clip. The clip according to the present invention includes a base with two lateral sides extending from the base. Attachment clips extend at a 90-degree angle from the lateral sides that allow for the attachment of the clip onto a flat surface or into a seat or panel. A plurality of holes are provided in the clip to allow for the insertion of mounting screws in two particular positions. First holes are provided in the attachments and the second holes are provided in the base. Once this clip is mounted a user may easily mount the clip and then holster a pistol within the clip as needed.

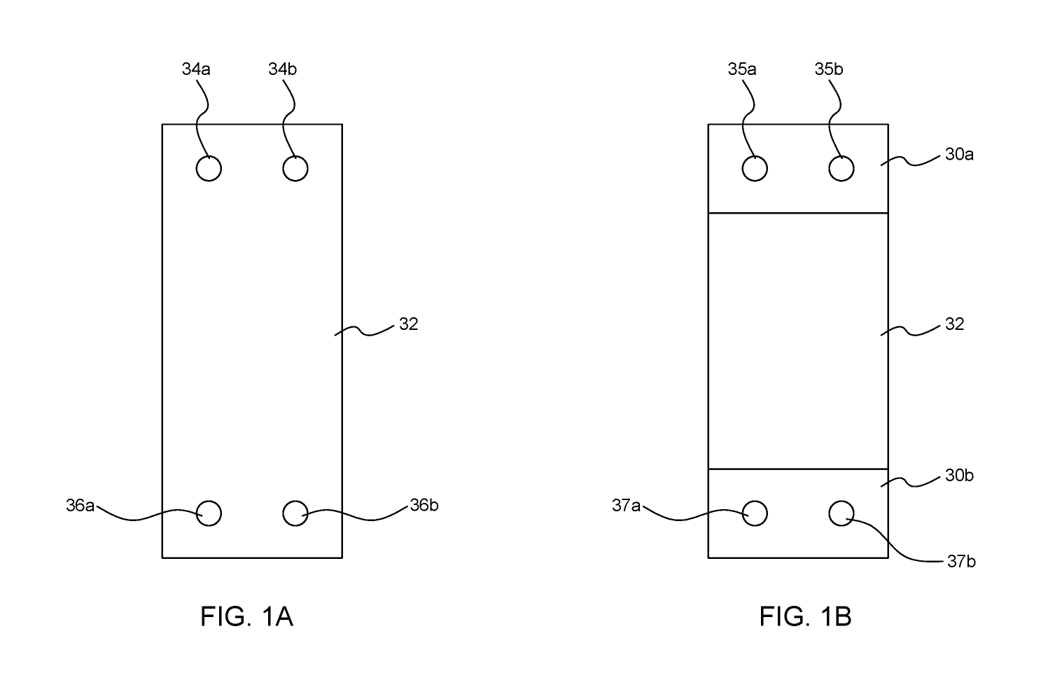

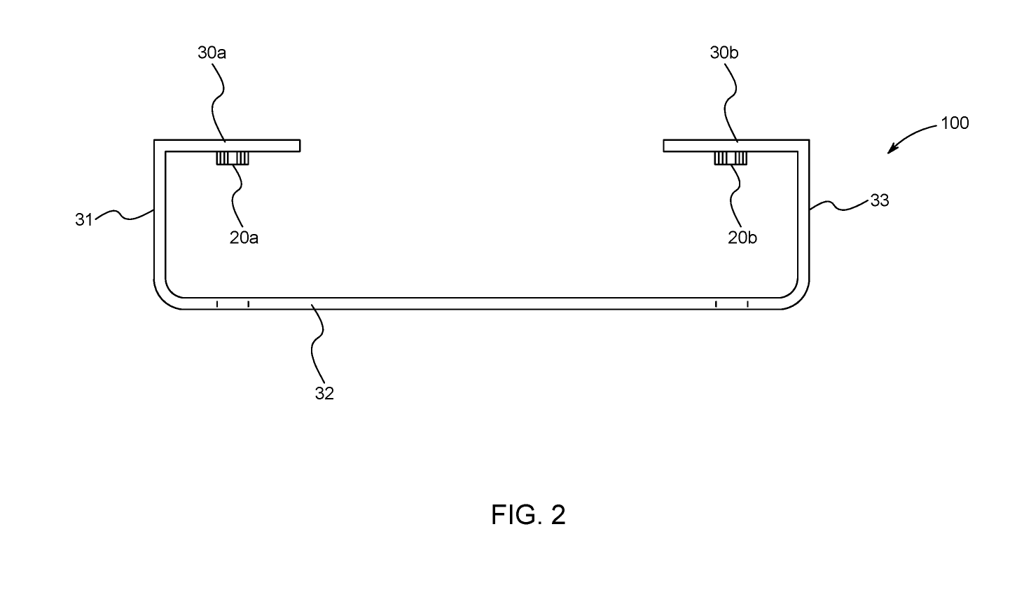

In reference to FIG. 1A, a first side view of the clip is depicted showing the bottom of a base 32. Base 32 includes four holes 34a, 34b, 36a, 36b. These holes 34a, 34b, 36a, 36b are provided for the user to insert further attachments to the base 32 to easily mount and holster a pistol within the clip 100. A reverse view of the base 32 is shown in FIG. 1B, where the mounting clips 30a, 30b are shown. The mounting clips 30a, 30b secure the clip 100 onto a flat surface. This aspect is more easily shown within the profile view of FIG. 2. The mounting clips 30a, 30b are shown extending at a 90-degree angle from lateral sides 31, 33 of the clip 100. These lateral support sides 31, 33 extend at a 90-degree angle from a base 32 as shown in FIG. 2.

Mounting screws as shown in FIG. 2, screws 20a, 20b, mount the clip 100 onto a flat surface within the vehicle. The screw inserts secure the clip into position and a user may easily slide the gun holster within an opening provided between the base 32 and attachment clips 30a, 30b. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A mountable clip to support a gun holster comprising:
a. a base;
b. a lateral support extending from each side of the base;
c. a mounting clip extending from each lateral support; and
d. a plurality of holes in each mounting clip and base adapted to provide a means to mount the clip onto a surface.

2. The mountable clip according to claim 1, where each lateral support extends at a 90-degree angle from the base.

3. The mountable clip according to claim 2, where each mounting clip extends at a 90-degree angle from the base.

4. The mountable clip according to claim 1, further including a screw for each hole for mounting the mountable clip.
